(19) United States
(12) Patent Application Publication
(10) Pub. No.: US 2005/0104387 A1
(43) Pub. Date: May 19, 2005

(54) Latch handle device

(76) Inventor: Ku Long Lin, Taichung (TW)

Correspondence Address: Liberty Patent and Trademark Office, P.O. Box 590, Taichung City, 400, TW

(21) Appl. No.: 10/712,901

(22) Filed: Nov. 14, 2003

(51) Int. Cl. E05B 3/00

(52) U.S. Cl. 292/336.3

(57) ABSTRACT

A latch handle device includes a base has a twist block and a positioning plate installed inside and a handle. One end of the handle formed into a column-shaped connecting post that is inserted inside the base, joined with the positioning plate, and communicating with the twist block. Thereby, the handle and the base are capable of 360-degree rotation in relation to each other before they are installed on a screen door. So, the relative angles between the handle and the base are adjusted to reduce the space required for packaging, thus reduce the packaging measurements and increase loading capacity for transportation.

### BACKGROUND OF THE INVENTION

(a) Field of the invention

The present invention relates to a latch handle device, particularly to one installed inside or outside on a screen door and engaged to the doorframe, only to be disengaged from the doorframe by turning the handle of the latch handle device.

(b) Description of the Prior Art

A regular screen door without a catching or engaging device is easily closed or opened by blowing wind, which would often result in damage to the door. To solve that problem, a user may install a latch set or a door closer, or use a door handle with catch or engaging function to secure the screen door in position.

Please refer to FIG. 1. A latch 17 installed on one side of a screen door 19 includes a main unit 10 and a handle 11. There is an engagement unit 18 installed between the handle 11 and the main unit 10. The engagement unit 18 is hinged on the handle 11, so the engagement unit 18 is capable of rotating along with the handle 11. On another side of the screen door 19 is optionally another latch handle 92 installed to match the latch handle 17. The latch handles 17, 92 are joined by means of a square turning shaft 93. When the screen door 19 is closed, the engagement unit 18 is engaged to the doorframe 91, so the screen door 19 will not open on its own. By turning the latch handle 17 or 92, the engagement unit 18 is disengaged from the doorframe 91, the screen door 19 then can be opened. The engagement unit 18 is hinged on the handle 11, so the engagement unit 18 is capable of retraction and swing. When the screen door 19 is closed, the engagement unit 18 comes in contact with the doorframe 91, and the engagement unit 18 retracts and passes the doorframe 91. When returning to its original position, the engagement unit 18 is again engaged with the doorframe 91.

Conventionally, the foregoing latch handle 17 is made by assemble the main unit 10 and the handle 11 into fix state. In other words, the relative angle between the main unit 10 and the handle 11 may change when subjected to a force, but the handle 11 and the main unit 10 will resume their perpendicular positions once the force is released.

Please refer to FIG. 2, due to the perpendicular positions of length of the handle 11 of the latch handle 17 and the length of the main unit 10, they occupy a larger space, hence a larger packing box 90 is required, this increase both the packing and transportation costs. FIGS. 3 and 4 show an innovated latch handle 17 wherein the lever 12 of the handle 11 is separated from the holder unit 13. When placed within a packing box 90, the length of the lever 12 may be positioned parallel to the length of the main unit 10, so as to reduce the space, using smaller packing boxes, reducing packing costs, and increasing higher loading capacity in transportation. But in assembling process, in addition to the installation of square turning shaft (not shown), a screw 14 must be used to join the lever 12 to the holder unit 13, which means inconvenience to the assembling process, because the screw 14 is small and can be lost easily, which requires stocking of ready spare parts to facilitate installation. Therefore, there is a need for improvement on the conventional latch handle 17.

### BRIEF DESCRIPTION OF THE INVENTION

To solve the problems of higher packaging costs and inconvenience in assembling process for the foregoing conventional latch handles, the present invention has provided a new latch handle device that can change the relative angle between the holder unit and the handle in packing, so as to occupy a smaller space, reduce the size of the packing box, reducing packing costs, increase transportation capacity, and facilitate assembling process.

To achieve the above objectives and performances, the present invention involves the design of the holder unit of the handle and the base in hinged connection, instead of direct joining process between the holder unit and the twist block. Thereby before installation to a screen door, the handle and the holder unit are capable of 360-degree rotation, thereby achieving the purpose of minimized space after making adjustment of the relative angle between the handle and the older unit.

Please refer to the following description of a preferred embodiment with drawings for better understanding of the objectives, performances and construction of the present invention.

### BRIEF DESCRIPTION OF DRAWINGS

FIG. 1 is an exploded view of a prior art of latch handle assembled on a door.

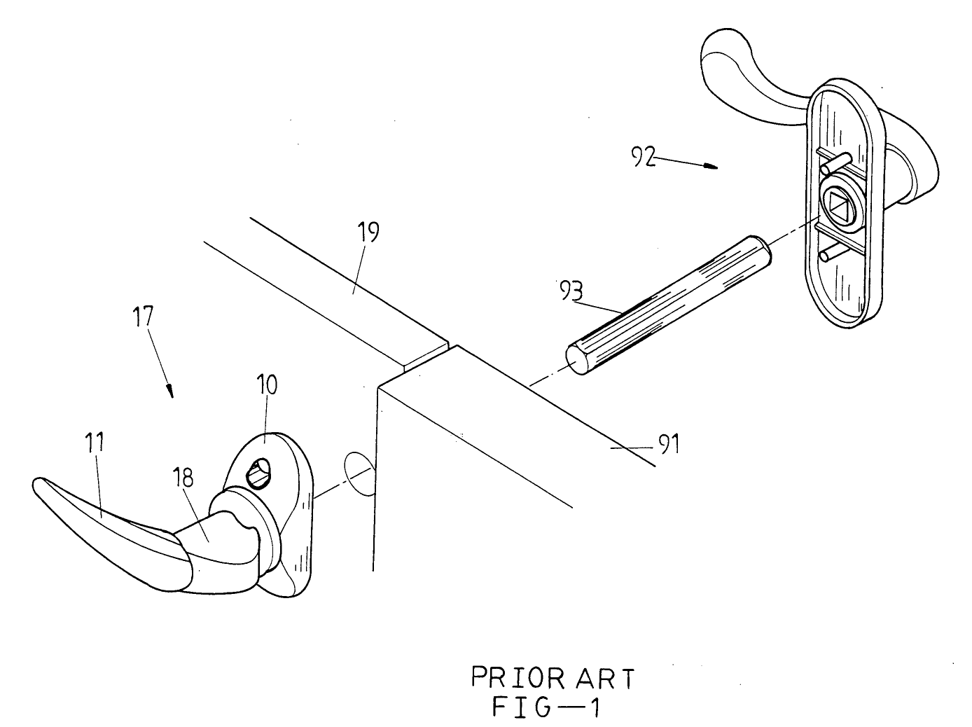

FIG. 2 is a schematic view of the prior art of latch handle packed in a box.

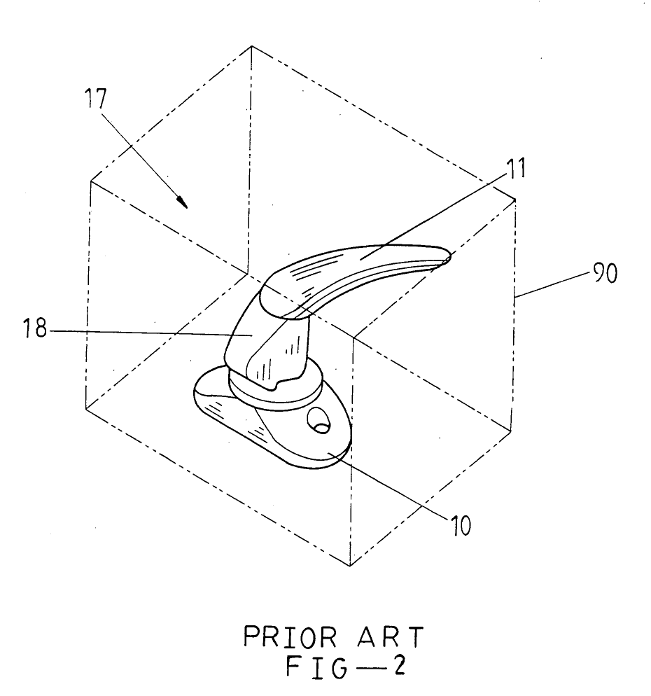

FIG. 3 is a schematic view of another prior art of latch handle.

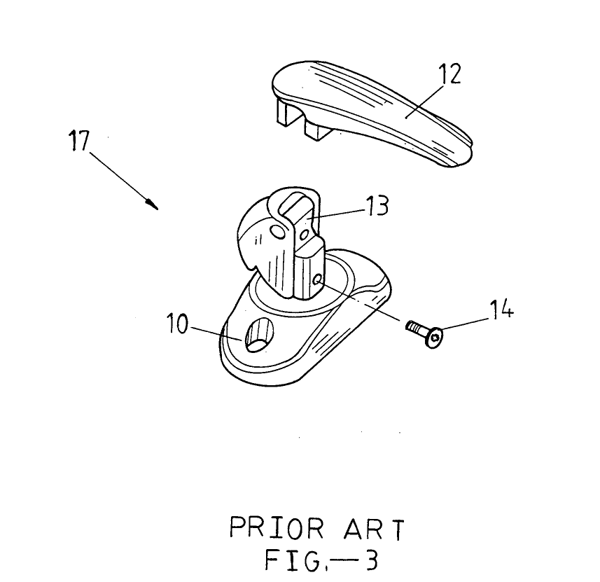

FIG. 4 is a schematic view of another prior art of latch handle packed in a box.

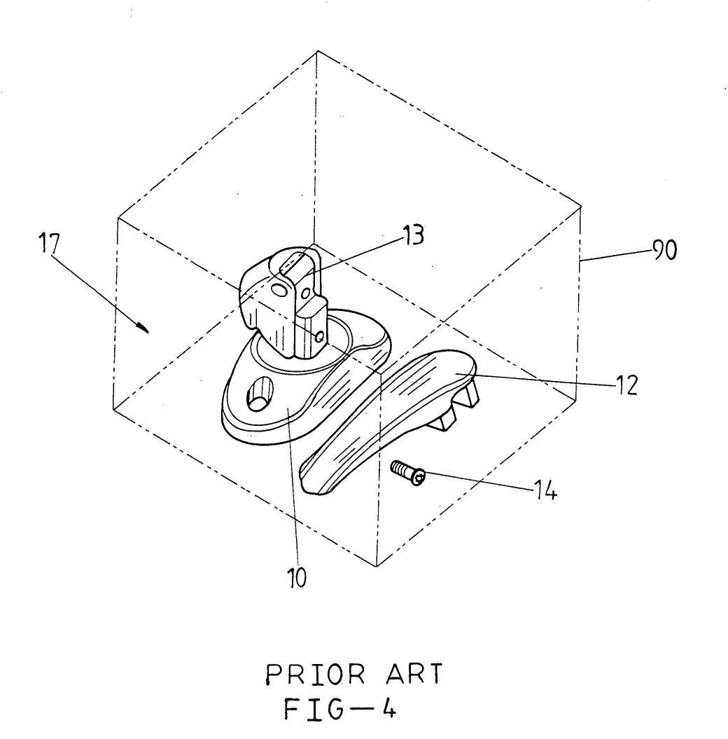

FIG. 5 is an exploded view of the present invention.

FIG. 6 is a schematic view of the present invention when assembled.

FIG. 7 is a perspective view of the present invention when the handle is turned.

FIG. 8 is a schematic view of the present invention when packed in a box without adjustment of angles of the handle and main unit.

FIG. 9 is a schematic view of the present invention when packed in a box after adjustment of angles of the handle and main unit.

FIG. 10 is a schematic view of the present invention when assembled for use.

### BRIEF DESCRIPTION OF THE NUMERALS

| | | | |
|---|---|---|---|
| 10 | main unit | 11 | handle unit |
| 12 | lever | 13 | holder unit |
| 14 | screw | 17 | latch handle |
| 18 | engagement unit | 19 | screen door |
| 90 | packing box | 91 | doorframe |
| 92 | latch handle | 93 | square turning shaft |
| 20 | base | 22 | assembling space |
| 24 | opening | 25 | opening |
| 26 | flange | 27 | flange |
| 30 | handle | 31 | handle |
| 32 | lever | 34 | holder unit |
| 35 | engagement unit | 36 | connecting post |
| 38 | shaft hole | 40 | positioning plate |
| 50 | twist block | 52 | bottom side |
| 54 | post | 56 | shaft hole |
| 58 | stop plate | 59 | stop plate |
| 62 | torsion spring | 64 | sealing plate |
| 70 | turning shaft | 72 | screen door |
| 74 | doorframe | 80 | packing box |

### DETAILED DESCRIPTION OF PREFERRED EMBODIMENTS

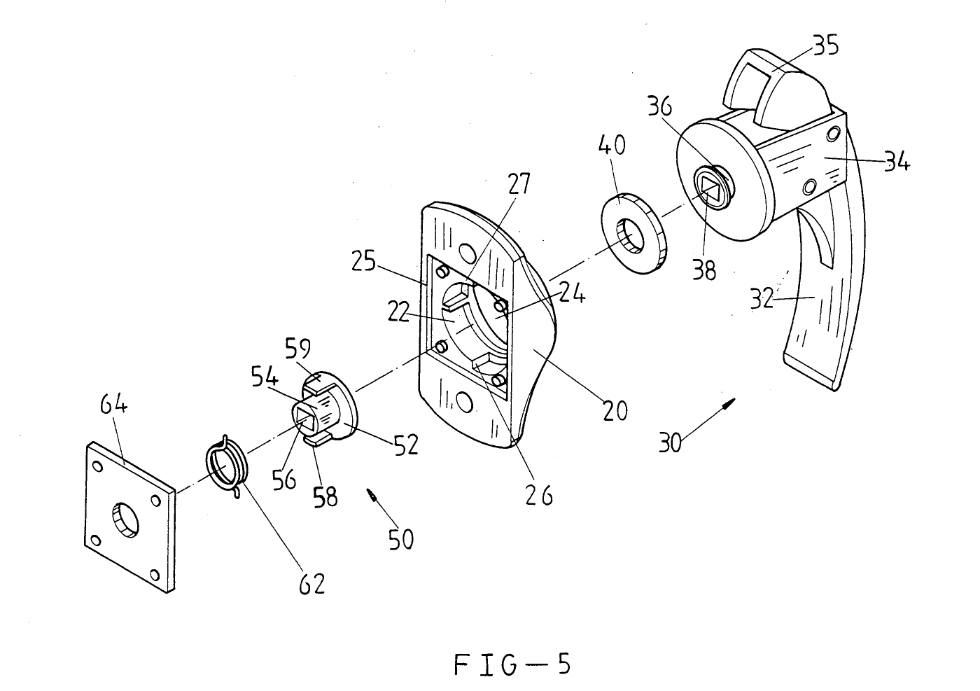

Please refer to FIG. 5. The latch handle disclosed in the present invention includes a base 20, a handle 30, a positioning plate 40 and a twist block 50. Inside the base 20 is provided an assembling space 22, two ends of the assembling space 20 being openings 24, 25. The wall of the assembling space 22 has a formation of two flanges 26, 27, each having a stepped formation.

The handle 30 includes a lever unit 32, a holder unit 34 and an engagement unit 35. The lever unit 32 is assembled and fastened to one end of the holder unit 34. The engagement unit 35 is connected to the holder unit 34. The engagement unit 35 is capable of flexible retraction and restoration to its former position. Provided at another end of the holder unit 34 is a column-shaped connecting post 36. The connecting post 36 has a square shaft hole 38 running axially.

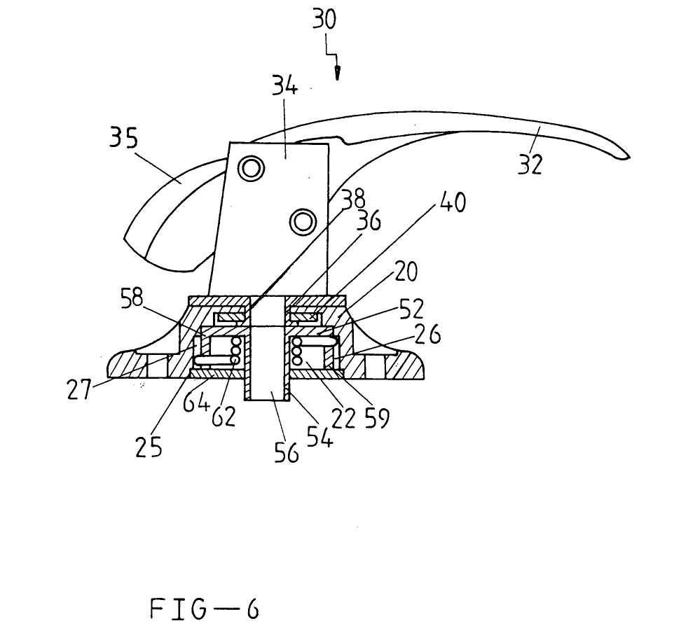

Please refer to FIG. 6. The connecting post 36 is installed in the assembling space 22 from one end of the base 20, so the holder unit 34 is resting on the base 20. The positioning plate 40 is mounted onto the connecting post 36, so the handle 30 is joined with the base 20.

Importantly, since the handle 30 and the base 20 are penetrated by connecting post 36 and riveted in place by the positioning plate 40, so the handle 30 and the base 20 are capable of 360-degree rotation in relation to each other.

Please refer to FIG. 5. The twist block 50 includes a bottom side 52 and a post unit 54. The post unit 54 extends perpendicularly from the bottom side 52. At the axis of the post unit 54 is provided a running-through square shaft hole 56. Extending from the margin of the bottom side 52 are two pieces of matching stop plates 58, 59. The stop plates 58, 59 are perpendicular to the bottom side 52. A torsion spring 62 is installed on the outer periphery of the post unit 54. Two ends of the torsion spring 62 are resting on the stop plates 58, 59.

As shown in FIG. 6, the twist block 50 and the torsion spring 62 are assembled inside the assembling space 22, so disposed that the shaft hole 56 at the axis of the post unit 54 is opposed to the shaft hole 38 at the axis of the connecting post 36, two ends of the torsion spring 62 are simultaneously extended and resting on the matching flanges 26, 27 formed on the wall of the assembling space 22. Finally, a sealing plate 64 is used to seal the opening 25 of the assembling space 22.

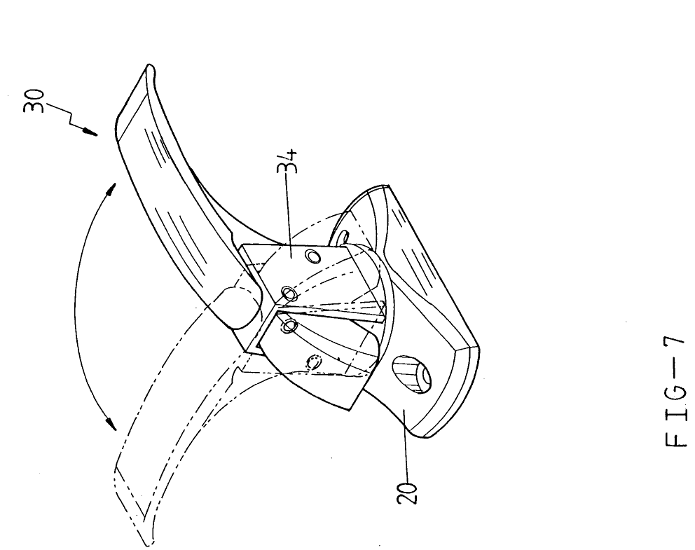

As shown in FIG. 6, the holder unit 34 of the handle 30 is not joined to the twist block 50, and the handle 30 is hinged merely by inserting the connecting post 36 in the base 20. As shown in FIG. 7, the holder unit 34 of the handle 30 and the base 20 are capable of rotation in relation to each other, with the twist block (not shown) remaining still and independent, so the handle 30 will not return to its original position because of release of a force applied after turning a specified angle.

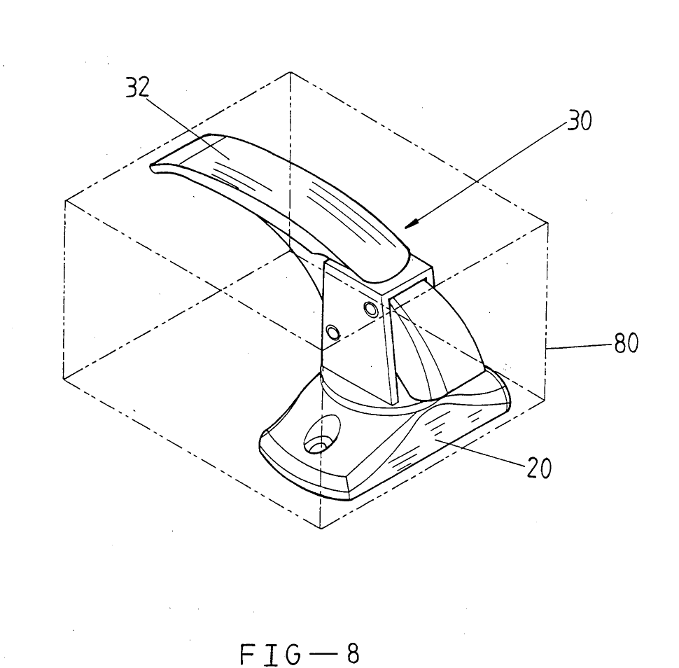

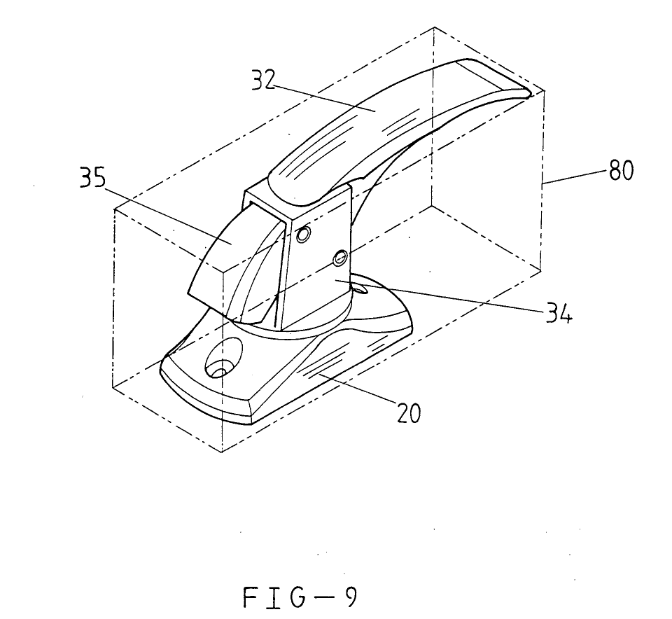

As shown in FIG. 8, a larger space will be occupied in case the handle 30 and the base 20 are so disposed that the length of the base 20 is perpendicular to the length of the lever unit 32 of the handle 30, thereby requiring a larger packing box 80. To overcome this problem, as shown in FIG. 9, the user can turn the holder unit 34 of the handle 30 to ninety degrees, so the length of the base 20 is parallel to the length of the lever unit 32 of the handle 30, thereby requiring a smaller packing box 80 to significantly reduce packing costs.

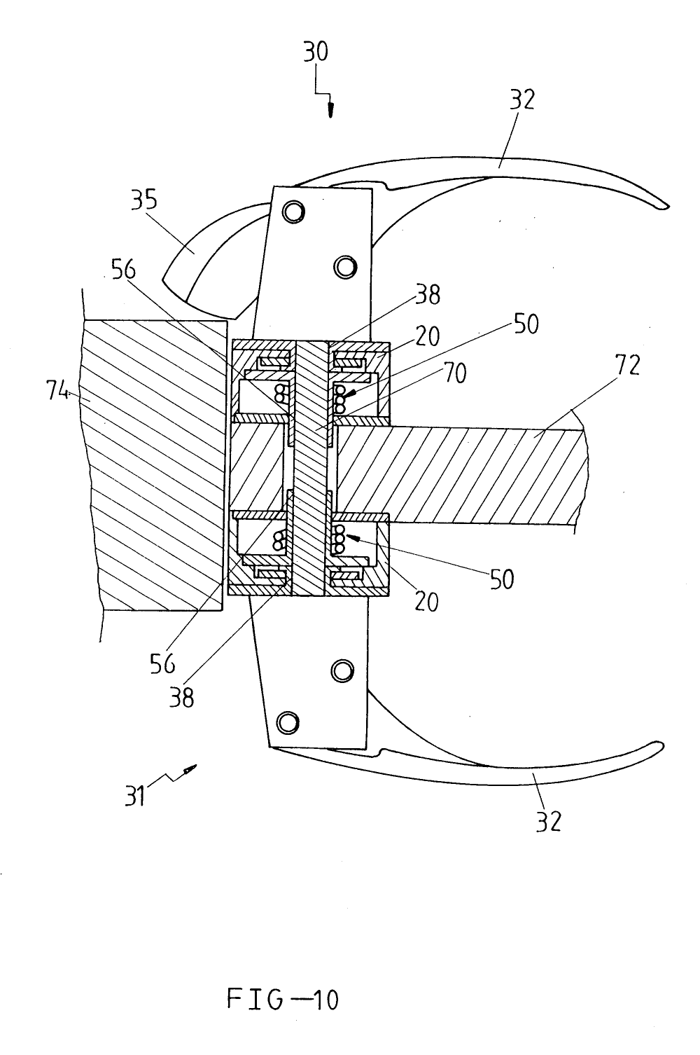

FIG. 10 shows how the present invention is installed, wherein two handles 30, 31 are used, the handle 30 having an engagement unit 35. Since the lever unit 32 and the holder unit 34 are already joined together, no additional screws are required for fastening purpose, permitting more convenient assembling process.

In the installation of two latch handles, the relative angles between the handles 30, 31 and the base 20 are adjusted in advance. Then, the latch handle devices are assembled to an inner side and an outer side of a screen door opposite each other. A square turning shaft 70 is installed between the latch handle devices, with two ends of the turning shaft 70 respectively located within the square shaft holes 38, 56 matching and communicating each other in the handles 30, 31 and the base, so the length of the lever unit 32 of the handles 30, 31 are perpendicular to the length of the base 20, and the handles 30, 31 are secured in place. Thereby, the latch handle devices on the inside and outside of the screen door 72 are capable of synchronous movement. When the screen door 72 is closed, the engagement unit 35 on the handle 30 is protruded and pushing against the doorframe 74. By applying a force to turn the handle 30, the engagement unit 35 will turn a specified angle and escape from the doorframe 74, so that the screen door 72 can be opened.

With the release of a force applied on the handle 30, the handle resumes its original position due to the action of the twist block 50, and the engagement unit 35 will be protruded. When the engagement unit 35 comes in contact with the doorframe 74, the engagement unit 35 will automatically retract, and protrude again after passing the doorframe 74 to enable engagement with the doorframe 74.

The above description has shown the simplified construction of the present invention, enabling the minimum space to be occupied by the handle 30 and the base 20 before the packing process, facilitating packaging process and reducing packaging and transportation costs. Since the lever unit 32 of the handle 30 and the holder unit 34 are joined together, there is no need for assembling process, and installation can be made easy and convenient. Moreover, there is no need to stock ready latching components, as is required in conventional models.

It is to be understood that the above description of preferred embodiments and drawings of the present invention are provided for explanation purpose, and shall not be based to restrict the scope of claim of the present invention, and that all equivalent skills and approaches deriving from the above shall be included in the spirit and scope of the following claims.

1. A latch handle device which be installed on a frame structure of a screen door, comprising:
a handle, having a lever and a holder unit, said lever being fastened to said holder unit, one end of the holder unit being a column-shaped connecting post;
a base, having an assembling space, a wall of said assembling space being formed of two flanges, the connecting post of the handle being penetrated in the assembling space;
a positioning plate, assembled with the connecting post in the assembling space of the base to keep the handle joined with the base;
an assembly of a twist block and a torsion spring located in the assembling space of the base, the twist block having a bottom side and a post unit perpendicularly to the bottom side, at an axis of the post unit being provided a polygonal shaft hole, on a periphery of the post unit being provided with the torsion spring, said twist block being assembled inside the assembling space, two ends of the torsion spring being respectively resting on the flanges of the assembling space;
thereby the handle and the base are capable of 360-degree rotation in relation to each other before the latch handle device being installed on a frame structure of a screen door.

2. A latch handle device as in claim 1, wherein the flanges formed on the wall of the assembling space are in stepped formation.

3. A latch handle device as in claim 1, wherein the twist block has stop plates extended from margins of the bottom side of the twist block, each stop plate being perpendicular to the bottom side, the stop plates serving to support two ends of the torsion spring.
